(19) United States
(12) Patent Application Publication
(10) Pub. No.: US 2004/0086071 A1
(43) Pub. Date: May 6, 2004

(54) Optimum evaluation system for safety analysis of a nuclear power plant

(76) Inventors: Chang Sup Lee, Yuseong-gu (KR); Hwang Yong Jun, Yuseong-gu (KR); Chang Kyung Sung, Yuseong-gu (KR); Yo Han Kim, Yuseong-gu (KR); Dong Hyuk Lee, Yuseong-gu (KR)

Correspondence Address: CANTOR COLBURN LLP, 55 Griffin South Road, Bloomfield, CT, 06002, US

(21) Appl. No.: 10/342,488

(22) Filed: Jan. 15, 2003

(30) Foreign Application Priority Data
Oct. 30, 2002 (KR) 2002-66533

(51) Int. Cl. G21C 17/00

(52) U.S. Cl. 376/259

(57) ABSTRACT

The present invention is an analysis method for simulating accidental phenomena that may occur in a nuclear power plant system and applying them to actual safety analysis of a power plant. The present invention is an optimum evaluation system for safety analysis, which may exactly simulate thermal hydraulic phenomena in the nuclear power plant system with obtaining a suitable safety margin for various kinds of virtual accidents.

### BACKGROUND OF THE INVENTION

1. Field of the Invention

The present invention relates to an optimum evaluation method for safety analysis of a nuclear power plant, and more particularly, to an analyzing method, wherein accidental phenomena that may occur in a nuclear power plant system can be simulated by the analyzing method and then applied to safety analysis of existing power plants. The present invention also relates to an optimum evaluation system for safety analysis which may exactly simulate thermal hydraulic phenomena in a nuclear power plant system with obtaining a suitable safety margin for various kinds of virtual accidents.

2. Description of the Related Art

Besides naturally generated energies, electric power is obtained by power of fire or explosion. Nuclear power plants use expansive power of air generated by nuclear fission. An nuclear reactor is provided in a nuclear power plant to make nuclear fission continuously. Because of the principles of the electric power generation, suitable safety standards and safety assurance needed in a nuclear power plant as a safety objective and a safety guideline have been discussed in active by experts or relevant international organizations or domestic organization controlling nuclear energy.

According to the conventional safety analysis method, it endows with maintainability in order to guarantee safety of a nuclear power plant regardless of uncertainty phenomena, models and input variables. However, regarding to safety evaluation, it is studied to be applied safety margin related with accident, i.e., applied in many fields of designs and operations of existing or a new unclear power plants via analysis for actual power plant behavior and standardization of related uncertainty.

### SUMMARY OF THE INVENTION

An object of the present invention is to provide an optimum evaluation system for safety analysis of a nuclear power plant, wherein data derived from results of a various kinds of experiments are used to improve codes so that the calculated results do not exceeds the experimental results at any condition, and then make the calculated results by a new technique of the optimum evaluation system could maintain a sufficient safety margin.

The object of the invention is achieved by quantification and standardization of the analysis method to 3 procedures and 14 steps for analyzing and evaluation, wherein:

a first procedure for applying the conditions and the codes consists of a step for describing an accidental scenario, a step for selecting a subject power plant, a step for confirming main conditions and deciding the raking, a step for selecting an optimum code, a step for arranging documents related with the codes, and a step for deciding applicability of the codes;

a second procedure for evaluating the codes and deciding displacement of variables consists of a step for evaluating codes and deciding evaluation matrix related with the displacement decision for the variables, a step for deciding nodding of a power plant, a step for deciding accuracy of the codes and the experiments, a step for analyzing and evaluating a scale effect decision, a step for deciding input variables of a nuclear reactor and their states related with the factors obtained by analyzing uncertainty and sensitivity, a calculating step of sensitivity of a power plant, a step for statistically evaluating uncertainty and a step for deciding a total uncertainty; and

a third procedure for analyzing sensitivity and evaluating uncertainty conducted by a step for evaluating bias which have not been considered in the first and the second procedures to decide a temperature of a final coating material.

### BRIEF DESCRIPTION OF THE DRAWINGS

The present invention will become more clearly appreciated as the disclosure of the invention made with reference to the accompanying drawings. In the drawings:

FIG. 1 is a flow chart that will be applied to an safety analysis of a nuclear power plant using an optimum evaluation system related with an embodiment of the present invention.

FIGS. 2a and 2b are tables showing priority preferences for major effect and consisting equipments that should be considered when a large-break loss of coolant accident is arisen in the present optimum evaluation system.

FIG. 3 is a code evaluation matrix for evaluating the large-break loss of coolant accident in the present optimum evaluating system.

### DETAILED DECRIPTION OF THE INVENTION

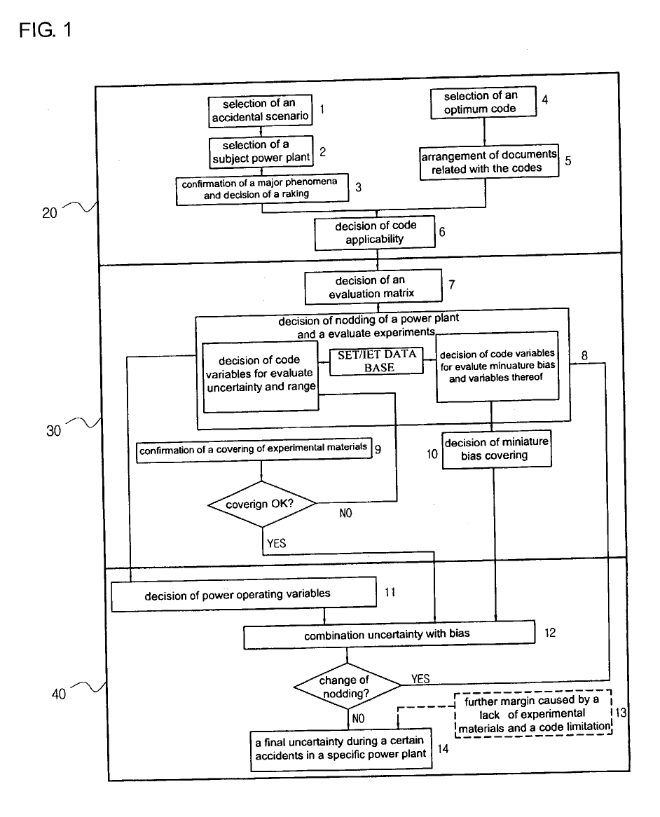

FIG. 1 shows a flow chart representing the total processes conducting a safety analysis of a nuclear power plant using an optimum evaluation system as an embodiment of the present invention. According to the present invention, analysis method is quantified and standardized to 3 procedures 20,30,40 and 14 steps 1˜14 so that accidental phenomena generated in a nuclear power planet system are simulated and applied to the safety analysis of a power plant. In other words, thermal hydraulic phenomena in the nuclear power plant system are exactly simulated with obtaining a suitable safety margins.

According to the, present safety analysis system, the first procedure 20 for deciding conditions and code applicability consists of following 6 steps 1˜6.

A 1^{st} step is to select an accidental scenario. During the 1^{st} step, a most limited accident in a various conditions is selected in order to decide broken position, and then the broken position is decided at the most proper position for maintenance using an optimum analysis codes (RELAP5, TRAC, CONTEMPT4/MOD5, RETRAN, GOTHIC etc.). In addition, according to a result of analyzing and evaluation of the various scenarios for a various accidents, thermal hydraulic effects are separated and analyzed in accordance with a bottom space of a nuclear reactor and the total stock of coolant of a core from a view of loss and recovery of coolant in the limited accident scenario since the safety margin is most inferior in the limited accident scenario (for example, generation of maximum nuclear fuel cladding temperature, etc.). Though, in this embodiment, a large-break loss of coolant accident is selected as the limited accident scenario in order to verify validity of application, the present invention can be applied to analyze all kinds of accidents that need safety analysis of a nuclear power plant.

A 2^{nd} step 2 is to select a subject power plant. GORI IlI and GORI IV of a representative 3 loop power plant of Wasting House Co. are selected as subject power plants. However, all kinds of nuclear power plants could be selected as the subject power plant.

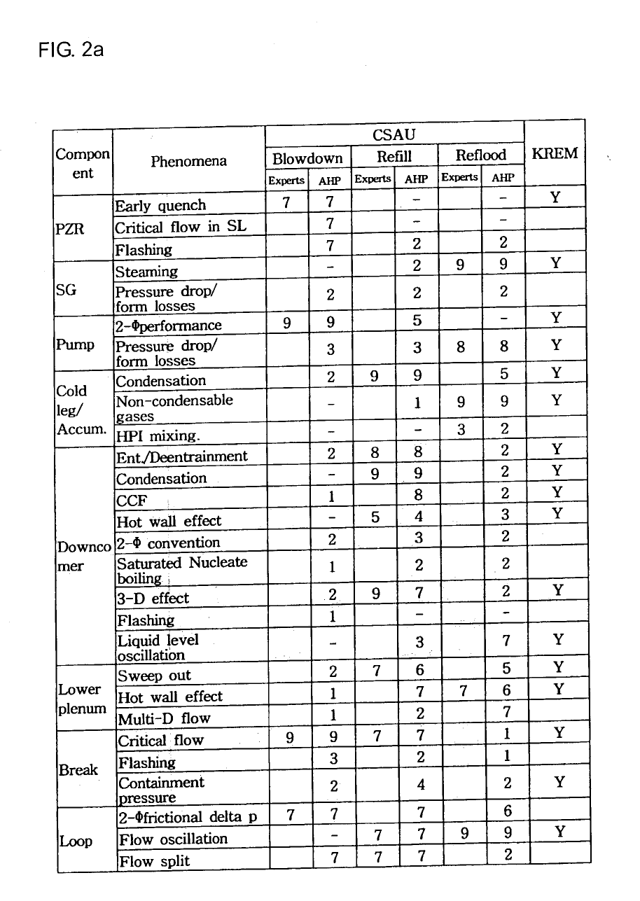

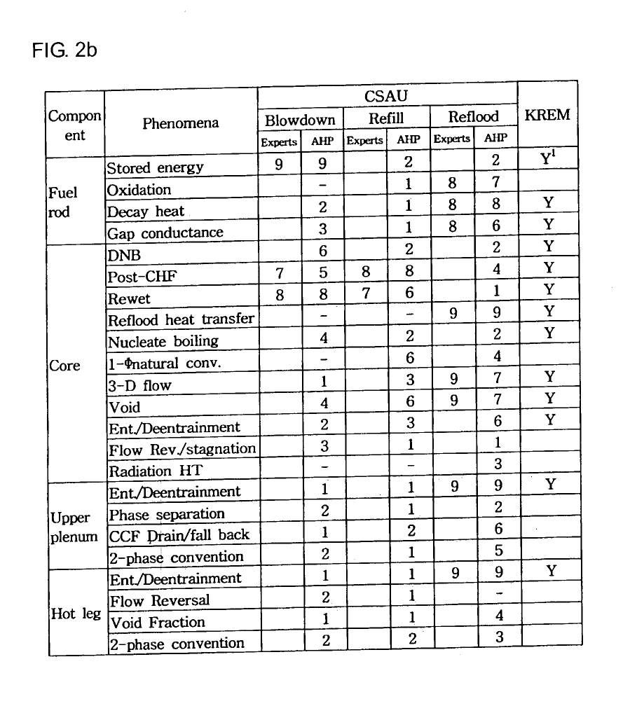

A 3^{rd} step 3 is to confirm major phenomena and decide the raking in which phenomena and processes are ranked according to their importance during the progress of a large-break loss of coolant accident. Confirmation of major phenomena and decision of raking are conducted through PIRT (Phenomena Identification Ranking Table), which is a set of opinions of experts. FIG. 2 shows priority preferences for the major phenomena and equipments that will be considered when a large-break loss of coolant accident is arisen in the optimum evaluation system. FIG. 2a shows priority preferences for the large-break loss of coolant accident offered by experts. FIG. 2b shows priority preference for the large-break loss of coolant accident offered by the present invention. In the present invention, on the basis of results of peer review by experts, PIRT of U.S nuclear safety regulatory commission is improved to be adopted as a standard.

A 4^{th} step 4 is to select an optimum code. The optimum analysis code selected by the present invention is KREM code (RELAP5/MOD3.1/K-CONTEMPT 4/MOD5). The optimum analysis code adopted by the present invention could be changed to any other optimum analysis code. The code systems are optimum thermal hydraulic codes of LAP5/MOD3.1 and CONTEMPT4/MOD5 developed by U.S. nuclear safety regulatory commission, wherein calculation ability of the codes for the optimum thermal hydraulic power is internationally authorized through international verification. However, the present invention selects the code named KREM code (RELAP5/MOD3.1/K-CONTEMPT4/MOD5) after improving the aforesaid 2 codes to suitable for analyzing of the large-break loss of coolant accident.

A 5^{th} step 5 is to arrange documents related with the codes. In this step, the documents related with the optimum evaluation codes used in the present invention are arranged. Furthermore, a database is constructed for quality control.

A 6^{th} step 6 is to decide code applicability, wherein applicability of the code system is decided by evaluating ability and limitation of the codes when the codes are adapted to a limited accident scenario and major phenomena. If the ability of codes is decided by examining the selected limited accident scenario and major phenomena, the followings could be evaluated via documents related with priority codes

Is this code system applicable to a limited accident scenario?

Is this code system applicable to a selected nuclear power plant?

Whether the applicability of this code system is limited to a certain model or correlation formula or not?

Isn't it impossible to apply the present code system because of a certain defect?

After the above particulars are examined, applicability of code requisition comparison code derived from the selection of the subject power plant and an accident scenario is decided.

The second procedure 30 is to evaluate the code and decide the displacement of the variables.

A 7^{th} step 7 is to decide an evaluation matrix. The evaluation matrix decided by the result of the 7^{th} step 7 contains a total effect experiment synthesizing separate effect experiments, essential elements and their related phenomena. The evaluation matrix should provide with the followings:

confirming an estimation ability of the codes for the limited accident phenomena

evaluation of accuracy of the codes

confirming an scale extension ability of the codes

decision of nodding

displacement decision for uncertainty variables

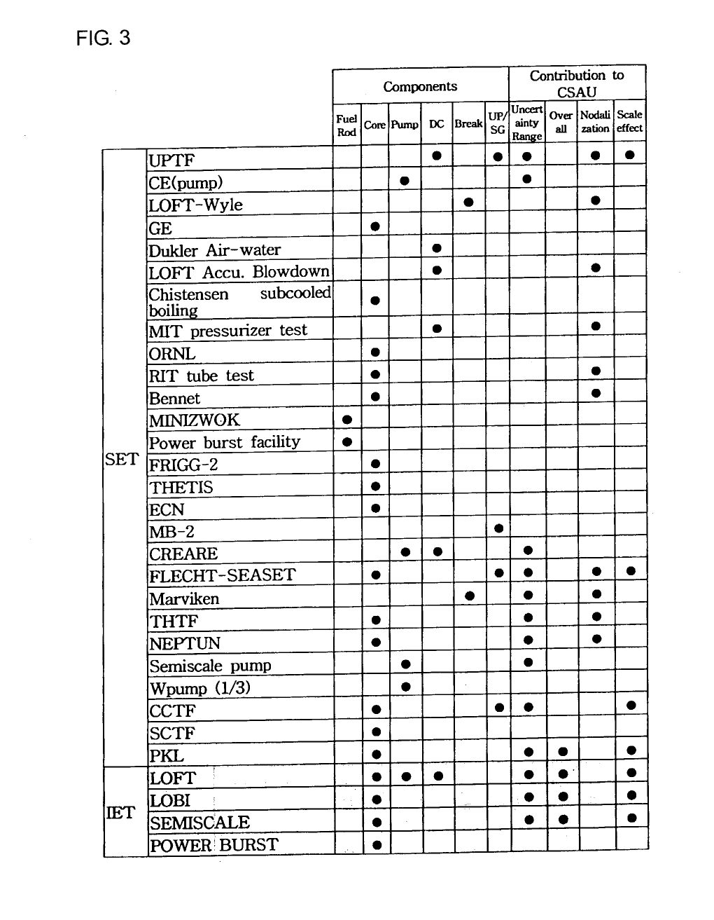

Accordingly, the present invention develops an evaluation matrix shown in FIG. 3.

FIG. 3 shows code evaluation matrix for evaluating a large-break loss of coolant accident in the present optimum evaluation system.

An 8^{th} step 8 is to decide nodding of a power plant and to evaluate experiments. In order to conduct an optimum calculation of a power plant, it needs decision for a suitable nodding for a major system. The nodding should be detailed as much as possible to show the design features of the power plant and major phenomena in case of accident. However, from an economical point of view like capacity of calculator and needed time for calculation, the nodding also should be simplified within the range that can capture the major phenomena. For selecting nodding, it should refer to experiences for the uses of codes, user guides for the codes and evaluation reports relating with the nodding. For selecting the nodding, it should reflect the code evaluation using separate effects of the evaluation matrix and the total effect experiments.

A 9^{th} step 9 is to confirm a covering of experimental materials. Evaluation calculation of the experimental materials shows whether the calculated value corrects the experimental result on the average. The most of experiments confirm that their results agreed with the calculated values. In this step, calculation is conducted only to the experiments selected in the 7^{th} step 7. The 7^{th} step is divided into 2 sub-steps, i.e., accuracy calculation step and confirming step of the experimental material covering.

The 9.1 step is to calculate code accuracy, wherein, the fact that the code corrects a certain experiment on the average means that the mean value of experimental values is agree with the mean value of the calculated values, even if in a certain experiment, the code calculation estimates a temperature of a coating material to low, and in another certain experiment, the code calculation estimates a temperature of the coating material to high. The standard deviation and bias are obtained by calculating dispersion with a difference between experimental value and calculated value. If the standard deviation is sufficiently less than absolute value and the bias is sufficiently less then the standard deviation, the code is called to have high accuracy. According to the present invention, the code accuracy is determined by comparison of the highest temperatures of coating materials obtained by experiments and by evaluation calculation. When the experiment and calculation present the highest temperatures of the coating materials at the different positions each other, the accuracy is defined by the difference of the respective highest temperature of the coating materials. It because sub-channel effects that a plurality heat rods or fuel rods present different temperatures even in the case that all thermal condition is the same to a plurality of heating rods or the fuel rods in the same node. Since the present invention does not adopt a sub-channel model, aforesaid dispersion of material is directly appeared as accuracy dispersion. An aberration of thermocouple of measuring equipments is about 5K. The aberration is not handled independently considering that the code accuracy considered by the present invention is look level.

The 9.2 step is to confirm the covering, in other words, this step is to confirm whether the kinds, the number and displacement of the selected respective code variables are sufficient or not. As it referred in CSAU of NUREG-1230, if uncertainty of all of the code variables is considered through bottom-up method, this 9.2 step is not needed. However, if top-down method is used, there is a need to find out major phenomena regarding every element and then select major code variables having limited numerals and controlling the major phenomena. Though the selection depends on experts' opinions, it is too subjective to avoid following questions.

Is the number of major variables sufficient?

Is their displacement sufficient?

How can evaluate the sufficiency?

The aforesaid questions may be concluded to the third question. If the reason for deciding the sufficiency is provided, the first and the second questions could be answered. As said before, the present invention provides the method of experimental material covering as an answer for the questions. For answering to the third question, the present invention uses code accuracy as a ground for evaluating the sufficiency of the number and displacement of variables. Accordingly, the present invention gives an objective reason to the code variables and displacement that are selected subjectively.

The meaning and process for confirming the experimental material covering are explained with an example of core behavior at the time of reflooding. The major variables affecting the coating material behavior can be selected among Dittos-Boelter correlation formula, Bromley correlation formula, minimum film boiling temperature correlation formula, and Zuber-CHF correlation formula. Each of displacement for the respective correlation formula could be found in documents. Here, an experiment of FLECHT-SEASET 31805 in which the code estimates the temperature of coating material to low is calculated. Though, it conducts a calculation after the selected respective code variables are dialed to increase the temperature of the coating material as high as possible, the calculated values still below the experimental values. This shows the kinds, the number and the displacement of the selected code are not suitable. If Chen correlation formula and Weber Number is added as code variables, it sufficiently exceeds the experimental values.

In the aforesaid example, the four code variables i.e., Dittus-Boelter correlation formula, Bromley correlation formula, minimum film boiling temperature correlation formula and, Zuber-CHF correlation formula etc., selected at first is not sufficient. Judging from the basis of code evaluation calculation. However, if Chen correlation formula and WeberNumber is added as code variables, the calculated vale exceeds the experimental vale. In other words, on the basis of code evaluation calculation, the six code variables of Dittus-Boelter correlation formula, Bromley correlation formula, minimum film boiling temperature correlation formula, Zuber-CHF correlation formula, Chen correlation formula and Weber Number can be called that they are select suitably with their displacement.

In principle, the above step is adapted to all experiments evaluating code accuracy to confirm the total experimental material covering. However, if an evaluated value already exceeds the maximum value of experimental materials, there is no need to conduct covering work for the experiment. Accordingly, the covering work for the experimental materials is conducted to the selected experiments of which code calculation under-estimates the experimental value from the experiments calculating the code accuracy.

Since the maximum temperature of coating material is defined as a probability value of 95% having the reliability of 95%, the actual confirming procedure is as follows. For selected experiments, code variables suitable to the respective experiments are selected and the displacements of every variable based on reference documents and engineering decision are applied to conduct Monte-Carlo simulation (MCS). MCS of the respective experiments conduct 59 calculations after obtaining 59 sets of variables via Simple Random Sampling (SRS) in a space of code variables suitable to the experiment. The limiting value of calculated result obtained like this has 95% probability and 95% tolerance. When the limiting value exceeds the experimental value, the confirming work is completed. The confirming work is conducted to at least one experiment among all kinds of experiments of 9.1 step, especially, the case that the calculation estimates the experiment to low is selected. By this way finally the total set of selected code variables and displacements may contain code accuracy obtained by experimental evaluation calculation in 9.1 step.

Of cause, if the covering confirming work is failed, it returns the 8^{th} step 8 to increase the kinds of code variables or increase displacements of already selected variables to repeat the work. The code variables and their displacements confirmed by code accuracy is inputted to the 12^{th} step 12.

The 10^{th} step 10 is for deciding miniature bias covering. The miniature bias treatment comprises bias treatment of down-comer and a bottom space behavior, and bias treatment related with an upper space behavior and steam binding. The work conducted in this step is to coincide computed code calculation with an actual power plant appearance. Especially, the steam binding bias for coinciding power plant calculation is evaluated in 12^{th} step 12.

Bias Treatment of Down-Comer and a Bottom Space Behavior

A. ECC bypass bias treatment

As described in the 8^{th} step 8, estimated error for the total weight of the coolants directly drained from the broken position bypassed the down-comer when they are discharged is calculated by an evaluation calculation of UPTF-4A experiment.

As a result of calculation, ECC bypass amount is estimated less than the experimental value. According to the present invention, the error of the total bypass amount is covered by setting it to 1000 kg. Consequently, bias of power plant calculation is evaluated in the 12^{th} step 12.

B. Water Level Drop Down Treatment of Down-Comer

Evaluation of estimate ability for the water level drop down of down-comer by bypass steam during reflooding of the optimum evaluation code is conducted via UPTF-25 experiment. The result of the calculation of the optimum evaluation code estimates the water level drop down of down-comer is estimated more than the experimental value. On the basis of the evaluation calculation, the present invention does not consider the bias for the water level drop down of the down-comer separately.

Bias Treatment Related with an Upper Space Behavior and Steam Binding

A. Bias Treatment for the Upper Space De-entrainment

Regarding the upper space behavior, the temperature of coating material is affected by two phenomena. The water stored in a high temperature tube and the upper space increase a head and then consequently, the increased head makes hard to reflooding, so that increase the temperature of the coating material. Water transported to a steam generator in the form of droplets raises up pressure-drop on both end of the steam generator because of evaporation in a tube. This makes it hard to directly reflooding so that it raises up the temperature of the coating material. However, regarding to the same amount of water, the temperature raise-up effect of the coating material by increment of water head is much less than the temperature raise up effect of the coating material by increment of pressure-drop in the steam generator. Therefore, according to the present invention, when annular flow is generated in a node of the upper space, percentage of the droplets is remarkably reduced, so that de-entrainment effect of the upper space is maximized. Meanwhile, the bias of the power plant calculation is evaluated in the 12^{th} step 12.

B. Bias Treatment of Steam Binding

The present invention conservatively treats a steam binding bias with a method evaporating the all droplets transported to the tub of the steam generator via the upper space of the nuclear reactor and the high temperature tube. In order to evaporate the droplets entirely, it makes each of the droplets in the tube to have the size of 0.1 micron. Furthermore, it maximizes the heat transfer from a downstream to an upstream by multiply 1.225 and 1.37 respectively to the heat transfer correlation formulas of Dittus-Boelter and Bromley. The steam binding bias of the power plant calculation is evaluated in the 12^{th} step 12.

The third procedure is to evaluate uncertainty and to analyze sensitivity.

The 11^{th} step 11 is to decide power plant operating variables, wherein, the general phenomena and major safety variables in the large-break loss of coolant accident of a power plant is varied depending on not only codes but also initial and boundary conditions used for analyzing. Distribution of output of the core, nuclear fuel variables, coolant pump behavior, safety injection system, and system variables like pressure and flux can be mentioned as the initial and boundary conditions of a power plant related with the limited accident analysis. It determines displacements and distribution of general operating variables.

The 12^{th} step 12 is for adaptation to an allowed standard by combining uncertainty and bias. In this step analysis is conducted by using code variables decided in the 9^{th} step 9, the code bias decided in the 10^{th} step 10 and power plant operating variables decided in 11^{th} step 11 via MCS (Monte-Carlo Simulation). The 30 numbers of variables are derived by just sampling them from the respective boundary of variables for the 30 variables, wherein the variables are decided in each step. With the derived numbers, an optimum analysis code is calculated. This step for an optimum analysis code calculation via the said sampling is repeated in 59 times. The highest temperature of coating material among the results obtained by the aforesaid repeated calculations becomes the value having 95% reliability and 95% probability. For the scale bias evaluation, it evaluates most limited cases among the 59 times MCS. Bias arisen by bypass effect of emergency core coolants, bias arisen by De-entrainment of the upper space of the nuclear reactor, and bias arisen by evaporation of droplets in the steam generator tube are independently evaluated. The followings aim to approve the suitability of the present invention.

1. Allowed Standard and the Limit of Application of KREM

It use an allowed standard by the provisions of the notice of Ministry of Science & Technology No. 2001-39 article 3. This invention uses the allowed standard to evaluate the highest temperature, maximum oxidation, and maximum generation rate of hydrogen of the coating material; and to evaluate core cooling features during safety injection period. Evaluation result of the bias is considered further to the most limited value among the 59 times MCS results in order to provide with a permitted value.

2. Power Plant Monte-Carlo Simulation

In this step, Monte-Carlo Simulation is conducted regarding to the limited condition by using the code variation decided in the 9^{th} step 9, code bias decided in the 10^{th} step 10, and the power plant operating variables decided in the 11^{th} step 11. By simple sampling, the 30 numbers of variables are derived from the respective boundary of 30 numbers of variables that are decided in each step. It calculates an optimum analysis code by using the derived numbers. This step for calculating an optimum analysis code via the said sampling is repeated in 59 times. The highest temperature of coating material among the results obtained by the aforesaid repeated calculation becomes the value having 95% reliability and 95% probability.

3. Scale Bias Evaluation

For the scale bias evaluation, it evaluates most limited cases among the 59 times MCS. Bias arisen by emergency core coolant bypass effect, bias arisen by De-entrainment of the upper space of the nuclear reactor, and bias arisen by evaporation of droplets in the steam generator tube are independently evaluated.

The 13^{th} and the 14^{th} steps are to standardize a final uncertainty, wherein the errors inevitably allowed in the upstream steps are considered. For example, automatic time step control of the optimum analysis code and errors in accordance with plot frequency, etc. Since the temperature of the coating material is evaluated within the maximum determined margin, a final result is obtained by reflecting them.

According to the present invention, transient phenomena and accidental phenomena of a power plant system are more exactly optimized and evaluated by optimizing maintenance regarding the phenomena that are more important than a safety analysis method.

Furthermore, the present invention can be applied not only a large-break loss of coolant accident but also a various kinds of analysis of accidents and transients. Since the optimum analysis evaluation system may quantitatively evaluate the margins allowed to a power plant, safety and economics can be increased.

What is claimed is:

1. An optimum evaluation system for safety analysis of a nuclear power plant, which is standardized in 3 procedures and 14 steps for analyzing and evaluating an accident analysis of the nuclear power plant, wherein:
a first procedure for deciding conditions and applicability of a code consists of a step for describing an accidental scenario, a step for selecting subject power plant, a step for confirming and raking major phenomena, a step for selecting an optimum code, a step for arranging documents related with the codes, a step for deciding code applicability;
a second procedure consists of a step for deciding evaluation matrix related with code evaluation and displacement decision of variables, a step for deciding nodding of power plant, a step for deciding accuracies of the code and experiments, a step for analyzing and evaluating scale effect decision to decide input variables of a nuclear reactor and their state related with analysis factors of sensitivity and uncertainty, a step for calculating sensitivity of the power plant, a step for statistically evaluating uncertainty, and a step for deciding total uncertainty;
a third procedure is for finally deciding a temperature of a coating material by evaluating bias which is not considered in the first and the second procedures.

2. The optimum evaluation system for safety analysis of a nuclear power plant according to the claim 1, wherein:
the most limited accident in a various states is selected to decide break position and applied to every accident analysis which needs safety analysis of a nuclear power plant during said the 1^{st} step for deciding scenario in the first procedure;
the 2^{nd} step for selecting subject power plant is applied to all nuclear power plants;
phenomena and processes generated during the progress of a large-break loss of coolant accident are ranked in accordance with their importance during said the 3^{rd} step for confirming major phenomena and deciding raking;
KERM code (RELAP5/MOD3.1/K-CONTEMPT 4/MOD5) is selected as the optimum code for a large-break loss of coolant accident on the basis of 2 codes during said the 4^{th} step for selecting an optimum code;
DB for arranging the documents relating with the used optimum evaluation codes and for quality control is established during said the 5^{th} step:
ability and limitation of the code is evaluated in the said 6^{th} step for deciding code applicability in order to handle the limited accident scenario and its major phenomena.

3. The optimum evaluation system for safety analysis of a nuclear power plant according to the claim 1, wherein:
the evaluation matrix which is decided during the said 7^{th} step of the second procedure contains a total effect experiment synthesizing separate effect experiments examining separate effects, major elements, and the effect related with the major elements;
during the 8^{th} step for decision of nodding and evaluation of experiments, it needs a proper nodding decision for a major system;
during the 9^{th} step for confirming experimental data covering, calculation is conducted only for the experiments selected in the 7^{th} step;
scale based bias treatment conducted in the 10^{th} for deciding scale bias comprises bias treatment of the bottom space behavior and down-comer, and bias treatment related with the upper space behavior and the steam binding.

4. The optimum evaluation system for safety analysis of a nuclear power plant according to the claim 1, wherein in order to select nodding, the experiences of codes, guide for code user and evaluation report related with nodding are referred; and code evaluation using separate effects and total effects of evaluation matrix is reflected in this step.

5. The optimum evaluation system for safety analysis of a nuclear power plant according to the claim 3, wherein the 9^{th} step consists of a 9.1 sub step for calculating the code accuracy and a 9.2 sub step for confirming the covering.

6. The optimum evaluation system for safety analysis of a nuclear power plant according to the claim 5, wherein during the 9.1 step, since the code accuracy is decided by comparison of the maximum temperatures of coating material respectively derived from experiment and from evaluation calculation, and sub-channel model is not adopted, dispersion of data directly represents dispersion of accuracy;
during 9.2 step for the confirmation of experimental data covering, it is confirmed whether the kinds, the number and displacement of the selected individual code variables are sufficient or not.

7. The optimum evaluation system for safety analysis of a nuclear power plant according to the claim 3, wherein the bias treatment of down-comer and the bottom space behavior comprises ECC bypass bias treatment and the down-comer water level drop down treatment; the bias treatment related with the upper space behavior and the steam binding comprises a bias treatment for de-entrainment of the upper space and a bias treatment of the steam binding.

8. The optimum evaluation system for safety analysis of a nuclear power plant according to the claim 1, wherein during the 11^{th} step of the third procedure for deciding operating variables of the power plant, all phenomena and major safety variables in calculation of the large-break loss of coolant accident are varied by not only the codes but also initial condition and boundary condition;
during the 12^{th} step for combing bias and uncertainty, analysis is conducted by the code variables decided in the 9^{th} step via MCS(Monte-Carlo Simulation), the code bias decided in 10^{th} step, and the operating variables of the power plant decided in the 11^{th} step; in the 13 and the 14 steps for standardization of the final uncertainty, the errors that is inevitably allowed in the upstream steps are considered.

9. The optimum evaluation system for safety analysis of a nuclear power plant according to the claim 8, wherein:
in the 12^{th} step, applied range of KREM and an allowed standard are used to evaluate the highest temperature of the coating material, the maximum oxidization of the coating material, the maximum hydrogen generating rate, and core cooling appearance during safety injection among allowed standards;
Monte-Carlo Simulation of a power plant is conducted to the limited condition by using all of the code variables decided in the 9^{th} step, code biases decided in the 10^{th} step, and operating variables of the power plant decided in the 11^{th} step; and
scale bias is evaluated to the most limited one among 59 times MCS.

10. An optimum evaluation system for safety analysis of a nuclear power plant consisting of:
a first procedure comprising a 1^{st} step in which the most limited accident in a various conditions is selected and applied for analyzing every accident that needs a safety analysis of a nuclear power plant; a 2^{nd} step in which a subject power plant is selected among all power plants; a 3^{rd} step for confirming major phenomena and deciding raking in which phenomena and processes produced during a progress of a large-break loss of coolant accident are ranked in accordance with their importance; a 4^{th} step for selecting the most suitable codes in which KREM code (RELAP5/MOD3.1/K-CONTEMPT 4/MOD5) is selected as the optimum analysis code that are suitable for analysis of the large-break loss of coolant accident on the basis of 2 codes, a 5^{th} step for arranging documents in which a database for arranging code documents related with the used optimum evaluation codes, and quality control; and a 6^{th} step for deciding code applicability in which a limited accident scenario and its major phenomena are handled by evaluating ability and limitation of the code;
a second procedure comprising a 7^{th} step for deciding an evaluation matrix containing a total effect experiment synthesizing separate effect experiments examining separate phenomena, and essential elements and phenomena related therewith; a 8^{th} step for deciding nodding of a power plant and evaluation of experiments, in which suitable decision for nodding is needed; a 9^{th} step for confirming experimental data in which calculation is conducted only to the experiments selected in the 7^{th} step; a 10^{th} step for deciding scale bias covering in which scale bias treatment contains bias treatment of down-comer and a bottom space behavior, and bias treatment related with a steam binding and an upper space behavior;
a third procedure comprising a 11^{th} step for deciding operation variables of a power plant in which all phenomena and essential safety variables in a calculation of the large-break loss of coolant accident of a power plant are varied by not only codes but also initial condition and boundary condition used in the analysis; a 12^{th} step for combining bias and uncertainty in which analysis is conducted by using all of the code variables decided in the 9^{th} step, the code bias decided in the 10^{th} step and, operating variables of a power plant decided in the 11^{th} step via power plant MCS(Monte-Carlo Simulation) and; a 13^{th} and a 14^{th} steps for standardization of the final uncertainty, in which errors inevitably allowed are considered.
